(19) United States
(12) Patent Application Publication
(10) Pub. No.: US 2022/0224394 A1
(43) Pub. Date: Jul. 14, 2022

(54) METHODS FOR CONTROLLING BEAM FAILURE DETECTION, WIRELESS DEVICES AND NETWORK NODES

(71) Applicant: Sony Group Corporation, Tokyo (JP)

(72) Inventors: Anders BERGGREN, Lund (SE); Fredrik RUSEK, Esloev (SE)

(21) Appl. No.: 17/613,056

(22) PCT Filed: Jun. 2, 2020
(86) PCT No.: PCT/EP2020/065197

§ 371 Date: Nov. 20, 2021

(30) Foreign Application Priority Data
Jun. 13, 2019 (SE) 1950703-7

(51) Int. Cl. H04B 7/06; H04W 76/19; H04W 74/08; H04L 1/20

(52) U.S. Cl. CPC H04B 7/0695; H04L 1/203; H04W 74/0841; H04W 76/19

(57) ABSTRACT

The present disclosure provides a method performed by a wireless device, for controlling beam failure detection. The wireless device comprises one or more beams configured to communicate with a network node. The method comprises receiving, from the network node, control signalling indicative of one or more parameters of a configuration setting to apply for beam failure detection. The method comprises measuring a beam quality metric of a serving beam. The method comprises detecting abeam failure based on the measured beam quality metric and the received control signalling.

The present disclosure pertains to the field of wireless communications. The present disclosure relates to methods performed by a wireless device for controlling beam failure detection, methods performed by a network node for controlling beam failure signalling between the wireless device and a network node, related wireless devices and related network nodes.

### BACKGROUND

The 5th Generation (5G) system of the 3rd Generation Partnership Project (3GPP) specifies the use of beamforming a mechanism used for concentrating transmitted energy on an intended receiver. Such a functionality involves configuring a network node acting as base station such that rather than transmitting and receiving signals omni-directionally within its coverage area, transmission of signals may be provided over narrower transmission beams.

However, using narrower transmission beams also makes the wireless communication system more susceptible to deterioration of the wireless link quality resulting in beam failure. A beam failure (BF), at the wireless device side, occurs when the signal quality is too poor for the wireless device to be able to decode the received signals. It is the wireless device's responsibility to declare a BF to the network node (e.g. gNB), by initiating a beam failure recovery (BFR) procedure as defined in 3GPP TS 38.321. However, the technical specifications fail to specify quantitatively what “too poor” means. It is, however, important for scheduling purposes that the wireless device avoids reporting BFs too often.

### SUMMARY

It is in the interest of a wireless device to maintain a high quality received signal, and it is therefore in its interest to start beam failure recovery procedure as soon as possible to avoid data interruption However, it is in the interest of the network node to maintain the same beam for the wireless device as long as possible. These two interests are conflicting.

Also, when a wireless device rotates, the wireless device may initiate repeated beam failure recovery procedures back and forth between same two beams in a ping pong similar fashion. This ping pong behavior may be detrimental to the wireless device and to the network node. Further the repeated BF recovery procedures may cause unnecessary switching and signalling overhead.

Accordingly, there is a need for devices and methods for controlling beam failure detection, which mitigate, alleviate or address the shortcomings existing and control beam failure detection by providing a configuration of the wireless device with one or more parameters of a configuration setting to apply for beam failure detection.

The present disclosure provides a method performed by a wireless device, for controlling beam failure detection. The wireless device comprises one or more beams configured to communicate with a network node. The method comprises receiving, from the network node, control signalling indicative of one or more parameters of a configuration setting to apply for beam failure detection. The method comprises measuring a beam quality metric of a serving beam. The method comprises detecting a beam failure based on the measured beam quality metric and the received control signalling.

Further, a wireless device is provided, the wireless device comprising: a memory circuitry, a processor circuitry, and a wireless interface. The wireless device is configured to perform any of the methods disclosed herein.

Advantageously, the disclosed wireless device can adapt to the network conditions by (re)configuring the parameter to be used in BF detection based on control signalling received from the network node. This can therefore reduce the likelihood of ping pong behaviour of the wireless device.

The present disclosure furthermore provides a method performed by a network node, for controlling beam failure signalling between the wireless device and a network node. The method comprises determining one or more parameters of a configuration setting to be applied by the wireless device for beam failure, BF, detection. The method comprises transmitting, to the wireless device, control signalling indicative of the one or more parameters.

Finally, a network node is provided, the network node comprising: a memory circuitry, a processor circuitry, and a wireless interface. The network node is configured to perform any of the methods disclosed herein.

It is an advantage of the present disclosure that the disclosed network node can control the BF signalling and enables (re)configuration of the one or more parameters of the configuration setting to be used in BF detection at the wireless device. This allows the network node to schedule the wireless devices in a more beneficial way from the network perspective. For example, in situations with high traffic, there is limited resources available for BF recovery and therefore the network node can seek to limit the number of BF declarations. For example, in low traffic situations, it is of minor importance to the network node if a certain wireless device declares BF, so then the network node can loosen the restriction or minimize the ping pong behaviour by providing the disclosed control signalling.

### BRIEF DESCRIPTION OF THE DRAWINGS

The above and other features and advantages of the present disclosure will become readily apparent to those skilled in the art by the following detailed description of exemplary embodiments thereof with reference to the attached drawings, in which:

FIG. 1 is a diagram illustrating an exemplary wireless communication system comprising an exemplary network node and an exemplary wireless device according to this disclosure,

FIG. 2 is a flow-chart illustrating an exemplary method, performed by a wireless device, for controlling beam failure detection according to this disclosure,

FIG. 3 is a flow-chart illustrating an exemplary method, performed by a network node of a wireless communication system, for controlling beam failure signalling between the wireless device and a network node according to this disclosure,

FIG. 4 is a block diagram illustrating an exemplary wireless device according to this disclosure,

FIG. 5 is a block diagram illustrating an exemplary network node according to this disclosure, and

FIG. 6 is a signalling diagram illustrating the signalling between an exemplary wireless device and an exemplary network node according to embodiments of this disclosure.

### DETAILED DESCRIPTION

Various exemplary embodiments and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

The figures are schematic and simplified for clarity, and they merely show details which aid understanding the disclosure, while other details have been left out. Throughout, the same reference numerals are used for identical or corresponding parts.

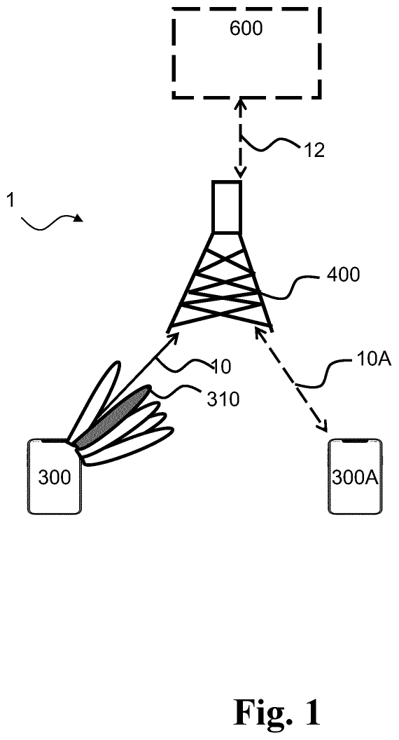

FIG. 1 is a diagram illustrating an exemplary wireless communication system 1 comprising an exemplary network node 400 and an exemplary wireless device 300 according to this disclosure.

As discussed in detail herein, the present disclosure relates to a wireless communication system 1 comprising a cellular system, e.g. a 3GPP wireless communication system. Various embodiments are outlined herein, generally suitable for employment e.g. in a 3GPP wireless communication network or system. Generally, all terms used in the claims and the description are to be interpreted according to their ordinary meaning in the technical field, unless explicitly defined otherwise herein.

The wireless communication system 1 comprises a wireless device 300 and/or a network node 400.

The term network node may refer to any suitable intermediary devices providing wireless communication, such as a relay node, a router, an access point, a base station, which is capable of connecting a wireless device to another wireless access node or connecting a wireless device to a core network (e.g. a core network node 600 via link 12). A network node disclosed herein refers to a radio access network node operating in the radio access network, such as a base station, an evolved Node B, eNB, gNB. The network node 400 may be configured to communicate with core network node 600 via link 12.

The wireless communication system 1 described herein may comprise one or more wireless devices 300, 300A, and/or one or more network nodes 400, such as one or more of: a base station, an eNB, a gNB and/or an access point.

The term wireless device may refer to any suitable terminal capable of wireless communication, such as a mobile phone or a portable computer. A wireless device may refer to as a mobile device and/or a user equipment, UE. The wireless device comprises for example a mobile phone, a tablet, a portable electronic device, an IoT device and/or a laptop.

The wireless device 300, 300A may be configured to communicate with the network node 400 via a wireless link (or radio access link) 10, 10A.

The term wireless link or radio link may refer to a radio channel connecting wireless communication devices such as UEs and network nodes with each other, and thus may refer to anyone of an uplink (UL), a downlink (DL).

Beamforming is a signal processing technique used for directional signal transmission or reception. Beamforming can be used at both transmitting and receiving sides in order to achieve spatial selectivity or directivity. In a typical beamforming configuration, a transmitter with an antenna array amplifies a signal by different “weights” at the respective antennas, and thus the signal experiences constructive interference at particular directions or sectors and destructive interference at other directions or sectors. As a result, it can have a desired sensitivity pattern where a main lobe, serving as a beam for transmitting the signal to a receiver (e.g. also called the serving beam), is produced together with nulls and side lobes. By adjusting the main lobe width and the side lobe levels, the position of a null can be controlled. This is useful to ignore noise or jammers in one particular direction, while listening for events in other directions. A similar result can be obtained on reception. For NR in 5G, beam management is one area of development and specification work. This may include beam measurement, for e.g. to be carried out by a UE to measure characteristics of received beamformed signals from a node configured for beamforming of the wireless network. Another feature may be beam reporting, wherein a UE may report information of beamformed signal(s) based on beam measurement.

The term beam may thus be seen as a spatial filter which separates one beam from other beams from the same emitting device.

Beam failure, as discussed throughout the present disclosure, refers to such a situation where a beam currently being used for communication between a transmitter and a receiver deteriorates below a certain value or becomes unavailable due to e.g., poor radio link quality. A variety of events such as UE mobility, appearance of obstacle and orientation change for a UE may deteriorate the radio link quality.

The details on measurement for each beam and BF detections are described in RAN1 specifications TS 38.214, and BFR is described in TS 38.321.

Typically, for communication between a wireless device 300 and a network node 400 of the wireless communication system 1, two or more beams 310 are available and one of them may be selected for serving the communication. The beam selected is referred to as the serving beam. For example, in the architecture of FIG. 1, the wireless device 300 and the network node 400 may communicate with each other via one or more of the beams 310. These beams may collectively be referred to be candidate beams. Among the candidate beams, one currently serving the communication or interaction may be referred to as a serving beam hereinafter, indicated by the shaded beam 310 in FIG. 1, whereas the other candidate beam(s) may be referred to as backup beam.

NR supports that UE can trigger a mechanism to recover from beam failure, so called beam failure recovery. Beam failure event may e.g. be defined as occurring when the quality of beam pair link(s) of an associated control channel falls low enough, e.g. below a threshold, time-out of an associated timer, or other. Mechanism to recover from beam failure is thus triggered when beam failure occurs. The network node may explicitly configure to the wireless device with resources for UL transmission of signals for recovery purpose. Configurations of resources may be supported where the network node is listening from all or partial directions, e.g., random access region. Transmission of DL signal is supported for allowing the wireless device to monitor the beams for identifying new potential beams.

One way to recover from beam failure is to use one of the backup beams to take over the coverage in case of the sudden beam loss of the serving beam. Note that the candidate beams in FIG. 1 are associated with the pair of wireless device 300 and network node 400. It is to be noted, in one or more embodiments, that some of the candidate beams may belong to the association of the wireless device 300 and with network node 400 and other candidate beams may belong to the association of the wireless device 300 and another network node.

A beam failure instance may be defined as an event when a signal (e.g. a control signal) from a network node 400 is poorly received in the wireless device 300. This may e.g. be determined based on signal strength, such as power or dB level, or as an attained error rate which exceeds a particular threshold. Such a signal may e.g. be a synchronization signal (e.g. synchronization signal block (SSB)), or a Channel State Information Reference Signal (CSI-RS). The error rate may e.g. be measured at Failure Detection Resources, e.g. based on attained block error rate (BLER) higher than a particular threshold. Beam failure is detected, determined or declared by counting beam failure instance indication from the lower layers to the medium access layer (MAC), or MAC entity.

The MAC entity may be configured by Radio Resource control (RRC) with a beam failure recovery procedure which is used for indicating to the serving network node of a new SSB or CSI-RS when beam failure is detected on the serving SSB(s)/CSI-RS(s). The indication of new SSB or CSI-RS indicates that the wireless device initiates a BF recovery procedure by initiating the Random Access procedure on a new beam corresponding to the SSB or CSI-RS.

Specific Beam Failure Indication Counters (BFIC) may be assigned to different signals. A possible mechanism for triggering beam recovery is that when all BFIC counters are non-zero and have overcome a predefined threshold, the wireless device 300 may indicate beam failure. When the signal has its error rate less than a threshold, it is viewed as a “no failure” event and otherwise a “failure” event. There are several drawbacks to this approach. If BFIC is kept constant when “no failure” event occurs, the wireless device only keeps tracks of failure events in a sequence of mixed failure and no failure events, even if the failure events occur sparsely over a period of time. This may trigger unnecessary beam recovery.

Another approach is to count only consecutive failure events and declare beam failure if the number is higher than a threshold in a predefined period of time (see 3GPP 38.321 chapter 5.17). This has the drawback that a BF is treated as a binary object, i.e., either there is a BF or there is not a BF. However, in reality, there can be a graduation of BF, such as a “mild BF” and a “severe BF”.

A further drawback of the approaches is that a multi-panel wireless device is not supported.

It is in the interest of a wireless device to maintain a high quality received signal, and it is therefore in its interest to start beam failure recovery procedure as soon as possible to avoid data interruption However, it is in the interest of the network node to maintain the same beam for the wireless device as long as possible. These two interests are conflicting.

With the above conflict of interest in mind, the present disclosure proposes to enable the network node to control the BF recovery procedure at the wireless by providing control signaling indicative of one or more parameters for configuration of the BF detection, which may lead to limiting or reducing unnecessary triggering of the BF recovery procedure at a higher layer of the wireless device. Accordingly, the disclosed technique allows to reduce or avoid the ping pong like behavior of the wireless device (e.g. when the BF trend is a repeated pattern where the BF occurs repeatedly between e.g. two beams).

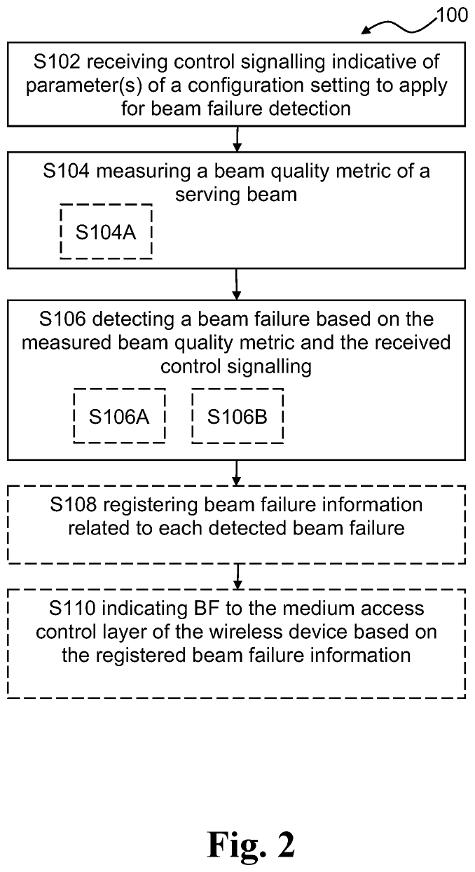

FIG. 2 shows a flow diagram of an exemplary method 100, performed by a wireless device, for controlling beam failure detection according to the disclosure. Stated differently, beam failure detection is herein defined as the process of determining whether reception of a signal transmitted in a particular beam (e.g. a serving beam) is satisfactory or not. A beam performance may not be satisfactory when measurements performed on a reference signal received using that beam do not satisfy a quality criterion (e.g. with respect to a threshold). For example, a measured received beam performance may be over a threshold, e.g. RSSI, RSRQ, which indicates that the corresponding beam is satisfactory to use or to continue to use. Radio conditions may vary and the measurements may get below a threshold, this may result in a BF detection, which indicates that the beam does not perform in a satisfactory manner. For example, a beam failure (BF), at the wireless device side, occurs when the signal quality is too poor for the wireless device to be able to decode the received signals. It is the wireless device's responsibility to declare a BF to the network node (e.g. gNB), by initiating a beam failure recovery (BFR) procedure as defined in 3GPP TS 38.321. Hence, controlling beam failure detection may be seen as controlling the condition to be fulfilled for BF detection at PHY so that the BF detection is indicated to the MAC for initiating the algorithm associated with the BF recovery procedure.

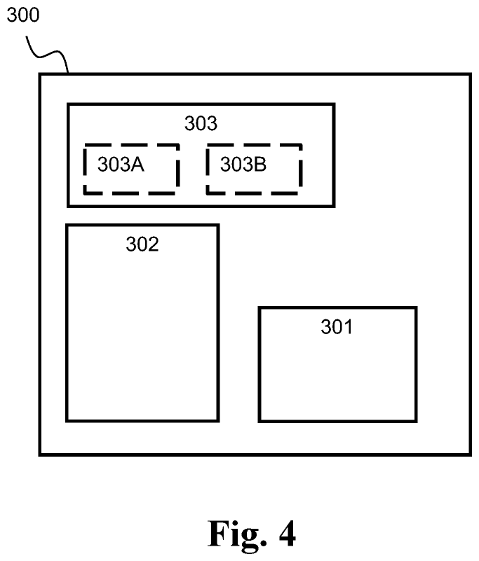

The method 100 is performed by a wireless device, such as the wireless device disclosed herein, such as wireless device of FIGS. 1 and 4.

The wireless device comprises one or more beams configured to communicate with a network node (e.g. the network node disclosed herein, the network node 400 of FIGS. 1, 3, and 5). The wireless device may communicate with the network node using one or more beams (illustrated in FIG. 1), including a serving beam, which is the beam used for transmission to the network node

The method 100 comprises receiving S102, from the network node, control signalling indicative of one or more parameters of a configuration setting to apply for beam failure detection. In other words, the one or more parameters may indicate a corresponding configuration setting to apply for beam failure detection. The control signalling may indicate or define a quality constraint to apply in the BF detection process. The indicated one or more parameters of the configuration setting may be determined by the network node based on the network condition assessed by the network node (e.g. traffic condition in the cell). The control signalling or the one or more parameters of the configuration setting may indicate a level of restriction. Conversely, the control signalling or the one or more parameters of the configuration setting may indicate a level of restriction loosening (e.g. a degree of freedom in BF detection). Control signalling may comprise one or more control signals, jointly indicating the f one or more parameters of the configuration setting to apply for beam failure detection. The control signalling may comprise one or more parameters indicating the configuration setting to apply for beam failure detection.

Optionally, the one or more parameters of the configuration setting indicate a quality constraint to be applied on the serving beam. For example, the control signalling may indicate the quality constraint to be applied on the serving beam (e.g. how well should the serving beam perform).

Stated differently, the network node indicates to the wireless device, via control signalling indicative of the one or more parameters, how restrictive the wireless device should be before declaring a BF.

A configuration setting may be characterized by one or more parameters which define, correspond to and/or set a configuration that the wireless device is to apply for detecting the failure of a serving beam. For example, the configuration setting may set a quality constraint or a quality level to be applied so as to detect a beam which performs below the quality level. The configuration setting may indicate a quality criterion, which when the quality criterion is not satisfied based on measuring on the reference signal(s) using the given beam, the wireless device detect that the beam is failing to satisfy the quality criterion.

The method 100 comprises measuring S104 a beam quality metric of a serving beam. As illustrated in FIG. 1, the serving beam is the beam 310 used by the wireless device for transmission to the network node. A beam quality metric may refer to a metric characterizing a radio quality of a particular beam, e.g. the serving beam. A beam quality metric may comprise one or more of: an error rate parameter (e.g. block error rate parameter), and a signal-to-noise ratio parameter, a signal-to-interference-noise ratio parameter. In one or more example methods, measuring S104 the beam quality metric of the serving beam comprises measuring S104A the beam quality metric of the serving beam based on one or more signals received on the serving beam. The beam quality metric may be associated with reception of the signal, which e.g. may be a pilot signal and/or a reference signal (e.g. a synchronization signal and/or control signal, such as SSB and/or CSI-RS). The beam quality metric may be determined on a physical layer in the wireless device and used in the beam failure detection. In one or more embodiments, the beam quality metric may include an indication of a degree of failure, in case of failure, e.g. indicating how much a BLER value has exceeded an error rate threshold, or how far below a signal strength threshold a detected signal strength value is. In certain embodiments, more than one type of beam quality may be reported, based on different received signals or different signal properties.

The method 100 comprises detecting S106 a beam failure based on the measured beam quality metric and the received control signalling. The detection S106 of the beam failure may be performed based on the measure beam quality metric and the one or more parameters of the configuration setting indicated in the control signalling. Detection S106 may comprise determining a BF event. Detecting S106 the BF is performed at the physical layer. In one or more example methods, detecting S106 the beam failure based on the measured quality metric and the received control signalling comprises determining S106A whether the beam quality metric satisfies a quality criterion based on the received control signalling (e.g. based on the one or more parameters of the configuration setting indicated in the control signalling). The one or more parameters of the configuration setting may indicate a quality criterion to be used in the BF detection. In one or more example methods, detecting S106 the beam failure based on the measured quality metric and the received control signalling comprises, upon determining that the beam quality metric does not satisfy the quality criterion, determining S106B that the beam failure, BF, is detected. For example, that the beam quality metric does not satisfy the quality criterion when the BLER as beam quality metric exceeds an error rate threshold (part of the quality criterion). For example, the BF detection S106 is performed before declaring BF, and may trigger initiating BF recovery. In other words, the BF detection may lead to declaring BF, and a possible initiation of the BF recover by a higher layer, such as the MAC layer.

In one or more example methods, the method 100 comprises registering S107 beam failure information related to each detected beam failure. In one or more example methods, registering S107 beam failure information may comprise counting each detected beam failure and/or storing, in a memory circuitry of the wireless device, beam failure information for each beam failure detected.

In one or more example methods, the method 100 comprises indicating S108, based on the registered beam failure information, to a medium access control layer of the wireless device that a beam failure recovery procedure is to be initiated by the medium access control layer. In one or more example methods, the method 100 comprises indicating, based on the registered beam failure information, to a layer of the wireless device higher that the physical layer of the wireless device, that a beam failure recovery procedure is to be initiated by the higher layer. The higher layer, such as MAC layer, may initiate the BF recovery procedure by attempting connection to the wireless network using a new beam in a random access (RACH) procedure using RACH preamble.

In one or more example methods, the one or more parameters of the configuration setting indicate a level of restriction to be applied in the BF detection. The one or more parameter may indicate one or more levels of restriction to be applied in the BF detection. In one or more example methods, the level of restriction may trigger an adaptation of the configuration setting, such as lowering down the quality constraint or restriction to be applied, and/or increasing the quality constraint or restriction to be applied in the BF detection. For example, the error rate threshold may be increased so as to lower the quality constraint or restriction to be applied. Conversely, for example, the error rate threshold may be decreased so as to increase the quality constraint or restriction to be applied. For example, the parameter may comprise a level of restriction k, where k=[1, 2, 3, . . . , K], where k=1 corresponds to a configuration where the wireless device can declare BFs at will (e.g. no restriction), and k=K corresponds to a configuration where the wireless device is as restrictive as possible before declaring BF (e.g. trigger BF event leading to BF instance indication to MAC). It is then up to wireless device to interpret k accordingly.

In one or more example methods, the one or more parameters of the configuration setting indicate threshold for detecting the beam failure and/or a weight factor for adjusting the detecting of the beam failure. The threshold for example comprises an error rate threshold, a SNR threshold, SINR threshold, a latency threshold, a SNS stability threshold (e.g. when there are repeated measurements) and/or a power threshold. For example, the one or more parameters can indicate a specific threshold value and optionally a plurality of weights. For example, the parameter value of a parameter for configuration of the BF detection is either adjusted to a first parameter value. Specifically, the first parameter value may be configured based on the received control signaling indicative of the corresponding parameter of the configuration setting. In various embodiments, this may involve obtaining the first parameter value x from the network node or applying a default parameter value. Alternatively, an indication of one or more weight factors w1 may be obtained from the network node, wherein the first parameter value x may be computed as x=s*w1 where s may be the current parameter value (or the default parameter value) and w1 is the received adjustment factor. For example, the first parameter value x may be set dependent on another value, e.g. a second value for No Failure detection. As an example, the second value y may be set to w3*x, where w3 is a weight factor. This weight w3 may have an associated default value, and/or be set based on an indication obtained from the network node in DL control signaling. The method may thus include a step of obtaining a weight factor w3 defining a ratio between the decrease and the increase to apply.

In one or more example methods, the one or more parameters of the configuration setting indicate one or more parameter values for any other algorithm to apply for BF detection.

In one or more example methods, the one or more parameters of the configuration setting indicate a block error rate, BLER, parameter for triggering a BF recovery procedure. In one or more example methods, the block error rate, BLER, parameter comprises a target BLER that must be reached within a specified time-frequency space. The parameter may indicate a time-frequency parameter during which the BLER is to be reached. In one or more example methods, the one or more parameters of the configuration setting indicate time-frequency space parameter according to which the parameter is to be applied, e.g. for the BF detection. In other words, a parameter of a configuration setting may indicate a time-frequency space parameter in which the parameter should be computed and applied in the BF detection. For example, the parameter can indicate over how long time-bandwidth, the BLER should be computed.

In one or more example methods, the parameter of the configuration setting indicates a BLER parameter k, where k=[1, 2, 3, . . . , K], where k corresponds to a certain BLER and a certain time-frequency space where the certain BLER should be computed.

In one or more example methods, the wireless device comprises a plurality of antenna panels, and wherein the one or more parameters of the configuration setting are associated with an antenna panel of the plurality of antenna panels. In other words, the one or more parameters may be indicated per panel. This allows for more granularity in controlling the BF detection mechanism. In other words, the network node may provide control signalling indicative of the one or more parameters of the configuration setting per panel. For example, the network node can provide the one or more parameters according to the level of restriction k per UE panel, a BLER parameter per UE panel, a threshold per UE panel. For example, for multi-panel wireless devices, the network node can set a very restrictive limitation for one panel, but a more relaxed on a “main” panel (because with multiple panels per UE, the number of beams to maintain in the network node increases, and therefore it is not realistic to assume that many beams can be of a high quality link).

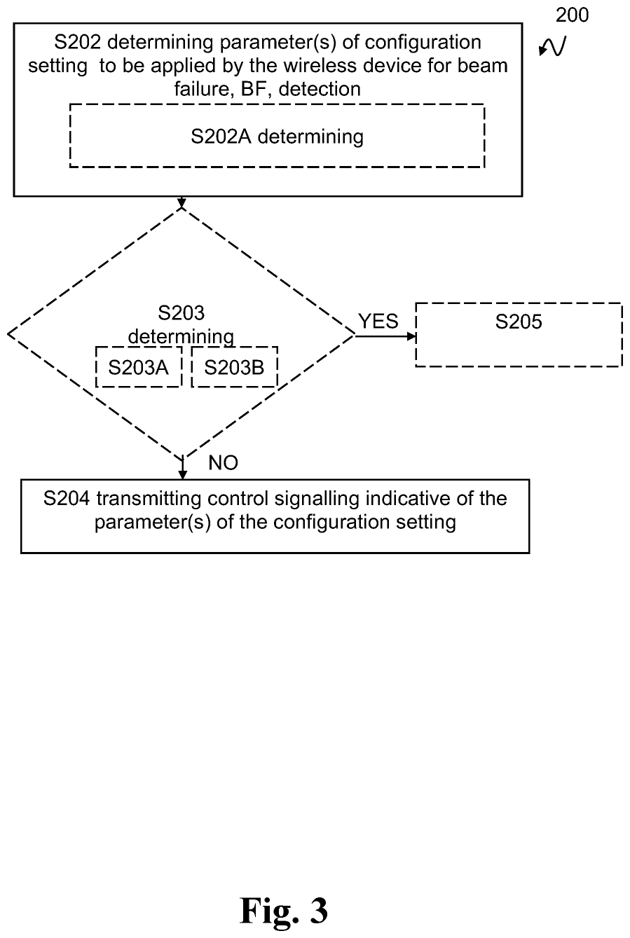

FIG. 3 shows a flow diagram of an exemplary method 200 performed by a network node according to the disclosure.

The method 200 is performed by a network node, for controlling beam failure signalling between a wireless device (e.g. the wireless device disclosed herein, e.g. wireless device 300 of FIGS. 1, 2, 4 and 6) and the network node. Stated differently, controlling beam failure signalling may be seen as controlling the signalling of the condition to be fulfilled for BF detection at PHY so that the BF detection is indicated to the MAC for initiating the algorithm associated with the BF recovery procedure.

The method 200 comprises determining S202 one or more parameters of a configuration setting to be applied by the wireless device for beam failure, BF, detection. In one or more example methods, determining S202 the one or more parameters comprises determining the one or more parameters of a configuration setting for detecting a sub-optimal behaviour of the beam failure detection. In one or more example methods, determining S202 the one or more parameters of the configuration to be applied by the wireless device for beam failure, BF, detection comprises determining 5202A the one or more parameters based on a traffic condition and/or mobility status of the wireless device.

Optionally, the one or more parameters of the configuration setting indicates a quality constraint on the serving beam.

For example, the network node can consider the traffic pattern of the UE, but also traffic priority, latency and other aspects in determining the one or more parameters of the configuration setting to be applied in BF detection.

For example, the network node can consider the mobility status of the wireless device, for example both when the wireless device is actually moving geographically, but also if the wireless device is just rotating (e.g. a gaming device that is mainly stationary but is rotating frequently).

The method 200 comprises transmitting S204, to the wireless device, control signalling indicative of the one or more parameters of the configuration setting. The one or more parameters are indicative of a configuration setting to be applied by the wireless device for beam failure, BF, detection. The wireless device is configured to receive the transmitted control signalling in step S102 of FIG. 2.

In one or more example methods, the method 200 comprises determining S203 whether a pattern of BF between two beams over a time period satisfies an improvement criterion. In one or more example methods, determining S203 whether the pattern of BF between two beams over the time period satisfies an improvement criterion comprises determining 5203A a number of Random access procedures initiated by the wireless device within the time period and determining 5203B whether the number of Random access procedures satisfies the improvement criterion (e.g. exceeds a threshold, that defines at what stage the BF detection is to be improved).

In one or more example methods, the method 200 comprises, upon determining that the pattern of BF between two beams over a time period satisfies the improvement criterion, transmitting S204, to the wireless device, control signalling indicative of the one or more parameters of the configuration setting.

In one or more example methods, the method 200 comprises, upon determining that the pattern of BF between two beams over a time period does not satisfy the improvement criterion, forgoing S205 transmitting, to the wireless device, control signalling indicative of the parameter.

In one or more example methods, the one or more parameters of the configuration setting indicate a level of restriction to be applied by the wireless device in detecting BF. For example, a parameter of a configuration setting may comprise a level of restriction k, where k=1, 2, 3, . . . , K, where k=1 corresponds to a configuration where the wireless device can declare BFs at will (e.g. no restriction), and k=K corresponds to a configuration where the wireless device is as restrictive as possible before declaring BF (e.g. trigger BF event leading to BF instance indication to MAC).

In one or more example methods, the one or more parameters of the configuration setting indicate a threshold for detecting of BF and/or a weight factor for adjusting the detecting of the beam failure.

In one or more example methods, the one or more parameters of the configuration setting indicate a block error rate, BLER, parameter for triggering a BF recovery procedure. In one or more example methods, a block error rate, BLER, parameter may comprise for example a target BLER that must be reached within a specified time-frequency space. The parameter may indicate a time-frequency space parameter during which the BLER is to be reached. In one or more example methods, the one or more parameters of the configuration setting indicate a time-frequency space according to which the parameter is to be applied.

In one or more example methods, the wireless device comprises a plurality of antenna panels, and wherein the one or more parameters of the configuration setting are associated with an antenna panel of the plurality of antenna panels. In other words, the one or more parameters may be indicated per panel. This allows for more granularity in controlling the BF detection mechanism. In other words, the network node may provide control signalling indicative of the one or more parameters of a configuration setting per panel. For example, the network node can provide the parameter according to the level of restriction k per UE panel, a BLER parameter per UE panel, a threshold per UE panel. For example, for multi-panel wireless devices, the network node can set a very restrictive limitation for one panel, but a more relaxed on a “main” panel (because with multiple panels per UE, the number of beams to maintain in the network node increases, and therefore it is not realistic to assume that many beams can be of a high quality link).

FIG. 4 shows a block diagram of an exemplary wireless device 300 according to the disclosure. The wireless device 300 comprises a memory circuitry 301, a processor circuitry 302, and a wireless interface 303. The wireless device 300 may be configured to perform any of the methods disclosed in FIG. 2.

The wireless device 300 is configured to communicate with a network node, such as the network node disclosed herein, using a wireless communication system. The wireless interface 303 is configured for wireless communications via a wireless communication system, such as a 3GPP system, such as a 3GPP system supporting beamforming.

The wireless interface 303 may comprise a first antenna panel 303A and a second antenna panel 303B.

The wireless device 300 is configured to receive (e.g. via the wireless interface 303), from the network node, control signalling indicative of one or more parameters of a configuration setting to apply for beam failure detection.

The wireless device 300 is configured to measure (e.g. via the processor circuitry 302) a beam quality metric of a serving beam.

The wireless device 300 is configured to detect (e.g. via the processor circuitry 302) a beam failure based on the measured beam quality metric and the received control signalling.

The processor circuitry 302 is optionally configured to perform any of the operations disclosed in FIG. 2 (S104A, S106A, S106B, S108, S110). The operations of the wireless device 300 may be embodied in the form of executable logic routines (e.g., lines of code, software programs, etc.) that are stored on a non-transitory computer readable medium (e.g., the memory circuitry 301) and are executed by the processor circuitry 302).

Furthermore, the operations of the wireless device 300 may be considered a method that the wireless device is configured to carry out. Also, while the described functions and operations may be implemented in software, such functionality may as well be carried out via dedicated hardware or firmware, or some combination of hardware, firmware and/or software.

The memory circuitry 301 may be one or more of a buffer, a flash memory, a hard drive, a removable media, a volatile memory, a non-volatile memory, a random access memory (RAM), or other suitable device. In a typical arrangement, the memory circuitry 301 may include a non-volatile memory for long term data storage and a volatile memory that functions as system memory for the processor circuitry 303. The memory circuitry 301 may exchange data with the processor circuitry 303 over a data bus. Control lines and an address bus between the memory circuitry 301 and the processor circuitry 302 also may be present (not shown in FIG. 4). The memory circuitry 301 is considered a non-transitory computer readable medium.

The memory circuitry 301 may be configured to store beam failure information for each beam failure detected in a part of the memory.

The memory circuitry 301 may be configured to store the level of restriction associated with signalled, the BLER associated with the signalled parameter, the threshold and weight factor associated with the signalled parameter.

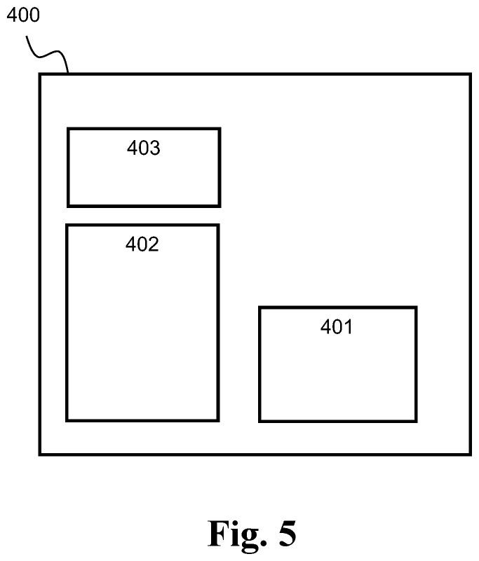

FIG. 5 shows a block diagram of an exemplary network node 400 according to the disclosure. The network node comprises a memory circuitry 401, a processor circuitry 402, and a wireless interface 403. The network node 400 is configured to perform any of the methods disclosed in FIG. 3. The network node 400 is configured to control beam failure signalling between the network node and a wireless device.

The network node 400 is configured to communicate with a wireless device, such as the wireless device 300 disclosed herein, using a wireless communication system (as illustrated in FIG. 1). The wireless interface 403 is configured for wireless communications via a wireless communication system, such as a 3GPP system, such as a 3GPP system supporting beamforming.

The network node 400 is configured to determine (e.g. via the processor circuitry 402) one or more parameters of a configuration setting to be applied by the wireless device for beam failure, BF, detection.

The network node 400 is configured to transmit (e.g. via the wireless interface 403), to the wireless device, control signalling indicative of the one or more parameters of the configuration setting.

The processor circuitry 402 is optionally configured to perform any of the operations disclosed in FIG. 3 (for example S202A, S203, S203A, 5203B, S205 of FIG. 3). The operations of the network node 400 may be embodied in the form of executable logic routines (e.g., lines of code, software programs, etc.) that are stored on a non-transitory computer readable medium (e.g., the memory circuitry 401) and are executed by the processor circuitry 402).

Furthermore, the operations of the network node 400 may be considered a method that the wireless circuitry is configured to carry out. Also, while the described functions and operations may be implemented in software, such functionality may as well be carried out via dedicated hardware or firmware, or some combination of hardware, firmware and/or software.

The memory circuitry 401 may be one or more of a buffer, a flash memory, a hard drive, a removable media, a volatile memory, a non-volatile memory, a random access memory (RAM), or other suitable device. In a typical arrangement, the memory circuitry 401 may include a non-volatile memory for long term data storage and a volatile memory that functions as system memory for the processor circuitry 402. The memory circuitry 401 may exchange data with the processor circuitry 402 over a data bus. Control lines and an address bus between the memory circuitry 401 and the processor circuitry 402 also may be present (not shown in FIG. 5). The memory circuitry 401 is considered a non-transitory computer readable medium.

The memory circuitry 401 may be configured to store the level of restriction associated with signalled, the BLER associated with the signalled parameter, the threshold and weight factor associated with the signalled parameter.

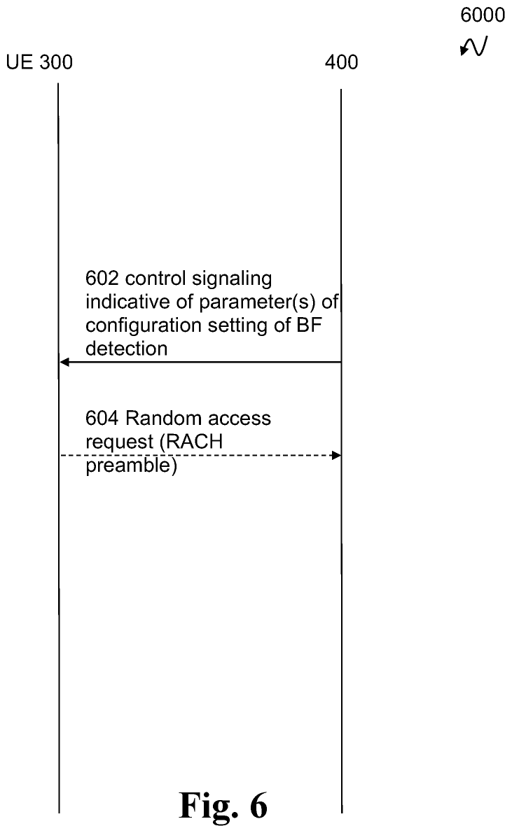

FIG. 6 is a signalling diagram 6000 illustrating the signalling between an exemplary wireless device 300 and an exemplary network node 400 according to embodiments of this disclosure.

The network node 400 determines one or more parameters of a configuration setting to be applied by the wireless device for beam failure, BF, detection. For example, the network node 400 can determine the one or more parameters based on a traffic condition and/or mobility status of the wireless device 300, or based on a pattern of BF between two beams over a time period which satisfies an improvement criterion (e.g. needs improvement, e.g. because the a beam failure recovery (BFR) is too frequent. e.g. the pattern shows a switching back and forth between the two beams).

The network node 400 transmits to the wireless device, UE 300, control signalling 602 indicative of the one or more parameters.

The wireless device 300 receives from the network node 400, control signalling indicative of the one or more parameters of the configuration setting to apply for beam failure detection.

The wireless device 300 measures a beam quality metric of a serving beam. The wireless device 300 detecting a beam failure of the serving beam based on the measured beam quality metric and the received control signalling.

Upon determining that the beam quality metric does not satisfy a quality criterion, the wireless device 300 determines that the beam failure, BF, is detected.

The wireless device 300 registers beam failure information related to each detected beam failure, and indicates, based on the registered beam failure information, to a medium access control layer of the wireless device 300 that a beam failure recovery procedure is to be initiated by the medium access control layer.

The wireless device 300 may initiate the BFR procedure by performing a random access procedure and transmitting a Random access request 604 including a RACH preamble.

Embodiments of methods and products (network node and wireless device) according to the disclosure are set out in the following items:
Item 1. A method, performed by a wireless device, for controlling beam failure detection, wherein the wireless device comprises one or more beams configured to communicate with a network node, the method comprising:
   receiving (S102), from the network node, control signalling indicative of one or more parameters of a configuration setting to apply for beam failure detection;
   measuring (S104) a beam quality metric of a serving beam; and
   detecting (S106) a beam failure based on the measured beam quality metric and the received control signalling.
Item 2. The method according to item 1, the method comprising:
   registering (S107) beam failure information related to each detected beam failure, and
   indicating (S108), based on the registered beam failure information, to a medium access control layer of the wireless device that a beam failure recovery procedure is to be initiated by the medium access control layer.
Item 3. The method according to any of the previous items, wherein detecting (S106) the beam failure based on the measured quality metric and the received control signalling comprises:
   determining (S106A) whether the beam quality metric satisfies a quality criterion based on the received parameter, and
   upon determining that the beam quality metric does not satisfy the quality criterion, determining (S106B) that the beam failure, BF, is detected.
Item 4. The method according to any of the previous items, wherein the one or more parameters indicate a level of restriction to be applied in the BF detection.
Item 5. The method according to any of the previous items, wherein the one or more parameters indicate a threshold for detecting the beam failure and/or a weight factor for adjusting the detecting of the beam failure.
Item 6. The method according to any of the previous items, wherein the one or more parameters indicate a block error rate, BLER, parameter for triggering a BF recovery procedure.
Item 7. The method according to any of the previous items, wherein the one or more parameters indicate a time-frequency space parameter according to which the parameter is to be applied.
Item 8. The method according to any of the previous items, wherein the wireless device comprises a plurality of antenna panels, and wherein the one or more parameters are associated with an antenna panel of the plurality of antenna panels.
Item 9. The method according to any of the previous items, wherein the one or more parameters indicate a quality constraint on the serving beam.
Item 10. A method, performed by a network node, for controlling beam failure signalling between a wireless device and the network node, the method comprising:
   determining (S202) one or more parameters of a configuration setting to be applied by the wireless device for beam failure, BF, detection; and
   transmitting (S204), to the wireless device, control signalling indicative of the one or more parameters.
Item 11. The method according to item 10, wherein determining (S202) the parameter indicative of restriction to be applied by the wireless device for beam failure, BF, detection comprises determining (5202A) the one or more parameters based on a traffic condition and/or mobility status of the wireless device.
Item 12. The method according to any of items 10-11, the method comprises:
   determining (S203) whether a pattern of BF between two beams over a time period satisfies an improvement criterion, and
   upon determining that the pattern of BF between two beams over a time period satisfies the improvement criterion, transmitting (S204), to the wireless device, control signalling indicative of the parameter.
Item 13. The method according to item 12, wherein determining (S203) whether the pattern of BF between two beams over the time period satisfies an improvement criterion comprises determining (5203A) a number of Random access procedures initiated by the wireless device within the time period and determining (5203B) whether the number of Random access procedures satisfies the improvement criterion.
Item 14. The method according to any of items 10-13, wherein the one or more parameters indicate a level of restriction to be applied by the wireless device in detecting BF.
Item 15. The method according to any of items 10-14, wherein the one or more parameters indicate a threshold for detecting of BF and/or a weight factor for adjusting the detecting of the beam failure.
Item 16. The method according to any of items 10-15, wherein the one or more parameters indicate a block error rate, BLER, parameter for triggering a BF recovery procedure.
Item 17. The method according to any of items 10-16, wherein the one or more parameters indicate a time-frequency space according to which the parameter is to be applied.
Item 18. The method according to any of items 10-17, wherein the wireless device comprises a plurality of antenna panels, and wherein the one or more parameters are associated with an antenna panel of the plurality of antenna panels.
Item 19. A wireless device comprising a memory circuitry, a processor circuitry, and a wireless interface, wherein the wireless device is configured to perform any of the methods according to any of items 1-9.
Item 20. A radio network node comprising a memory circuitry, a processor circuitry, and a wireless interface, wherein the radio network node is configured to perform any of the methods according to any of items 10-18.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-6 comprises some circuitries or operations which are illustrated with a solid line and some circuitries or operations which are illustrated with a dashed line. The circuitries or operations which are comprised in a solid line are circuitries or operations which are comprised in the broadest example embodiment. The circuitries or operations which are comprised in a dashed line are example embodiments which may be comprised in, or a part of, or are further circuitries or operations which may be taken in addition to the circuitries or operations of the solid line example embodiments. It should be appreciated that these operations need not be performed in order presented. Furthermore, it should be appreciated that not all of the operations need to be performed. The exemplary operations may be performed in any order and in any combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the exemplary embodiments may be implemented at least in part by means of both hardware and software, and that several “means”, “units” or “devices” may be represented by the same item of hardware.

The various exemplary methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly to be regarded in an illustrative rather than restrictive sense. The claimed disclosure is intended to cover all alternatives, modifications, and equivalents.

1. A method, performed by a wireless device, for controlling beam failure detection, wherein the wireless device comprises one or more beams configured to communicate with a network node, the method comprising:
receiving, from the network node, control signalling indicative of one or more parameters of a configuration setting to apply for beam failure detection;
measuring a beam quality metric of a serving beam; and
detecting a beam failure based on the measured beam quality metric and the received control signalling.

2. The method according to claim 1, the method comprising:
registering beam failure information related to each detected beam failure, and
indicating, based on the registered beam failure information, to a medium access control layer of the wireless device that a beam failure recovery procedure is to be initiated by the medium access control layer.

3. The method according to claim 1, wherein detecting the beam failure based on the measured quality metric and the received control signaling comprises:
determining whether the beam quality metric satisfies a quality criterion based on the received parameter, and
upon determining that the beam quality metric does not satisfy the quality criterion, determining that the beam failure, BF, is detected.

4. The method according to claim 1, wherein the one or more parameters of the configuration setting indicate one or more of:
a level of restriction to be applied in the BF detection,
a threshold for detecting the beam failure and/or a weight factor for adjusting the detecting of the beam failure,
a block error rate, BLER, parameter for triggering a BF recovery procedure, and
a time-frequency space parameter according to which the parameter is to be applied.

5. The method according to claim 1, wherein the wireless device comprises a plurality of antenna panels, and wherein the one or more parameters of the configuration setting are associated with an antenna panel of the plurality of antenna panels.

6. The method according to claim 1, wherein the one or more parameters of the configuration setting indicate a quality constraint on the serving beam.

7. A method, performed by a network node, for controlling beam failure signaling between a wireless device and the network node, the method comprising:
determining one or more parameters of a configuration setting to be applied by the wireless device for beam failure, BF, detection; and
transmitting, to the wireless device, control signalling indicative of the one or more parameters of the configuration setting.

8. The method according to claim 7, wherein determining the one or more parameters of the configuration setting to be applied by the wireless device for beam failure, BF, detection comprises determining the one or more parameters of the configuration setting based on a traffic condition and/or mobility status of the wireless device.

9. The method according to claim 7, the method comprises:
determining whether a pattern of BF between two beams over a time period satisfies an improvement criterion, and
upon determining that the pattern of BF between two beams over a time period satisfies the improvement criterion, transmitting, to the wireless device, control signalling indicative of the parameter.

10. The method according to claim 9, wherein determining whether the pattern of BF between two beams over the time period satisfies an improvement criterion comprises determining a number of Random access procedures initiated by the wireless device within the time period and determining whether the number of Random access procedures satisfies the improvement criterion.

11. The method according to claim 7, wherein the one or more parameters of the configuration setting indicate one or more of:
a level of restriction to be applied by the wireless device in detecting BF,
a threshold for detecting of BF and/or a weight factor for adjusting the detecting of the beam failure,
a block error rate, BLER, parameter for triggering a BF recovery procedure, and—a time-frequency space according to which the parameter is to be applied.

12. The method according to claim 7, wherein the wireless device comprises a plurality of antenna panels, and wherein the one or more parameters are associated with an antenna panel of the plurality of antenna panels.

13. A wireless device comprising a memory circuitry, a processor circuitry, and a wireless interface, wherein the wireless device is configured to perform the method according to claim 1.

14. A radio network node comprising a memory circuitry, a processor circuitry, and a wireless interface, wherein the radio network node is configured to perform the method according to claim 7.
